(19) United States
(12) Patent Application Publication
(10) Pub. No.: US 2026/0318500 A1
(43) Pub. Date: Oct. 15, 2026

(54) RADIATION-RESISTANT LED LAMP MODULE

(71) Applicant: Paragon Semiconductor Lighting Technology Inc., Diamond Bar, CA (US)

(72) Inventor: CHIA-TIN CHUNG, Midland, MI (US)

(21) Appl. No.: 19/450,673

(22) Filed: Jan. 15, 2026

(30) Foreign Application Priority Data
Apr. 14, 2025 (TW) 114203641

(51) Int. Cl. F21V 3/06; F21V 7/06; F21V 17/12; F21V 29/70; F21V 31/00; F21Y 105/16; F21Y 115/10

(52) U.S. Cl. CPC F21V 3/061; F21V 7/06; F21V 17/12; F21V 29/70; F21V 31/00; F21Y 2105/16; F21Y 2115/10

(57) ABSTRACT

A radiation-resistant LED lamp module includes at least one illumination light-generating structure, at least one top radiation-resistant structure, at least one radiation-resistant light-transmitting structure, and at least one bottom radiation-resistant structure. The top radiation-resistant structure includes a top radiation-resistant element disposed above the illumination light-generating structure. The radiation-resistant light-transmitting structure includes a first radiation-resistant light-transmitting element disposed above the illumination light-generating structure and a second radiation-resistant light-transmitting element disposed above the first radiation-resistant light-transmitting element. The bottom radiation-resistant structure includes a bottom radiation-resistant element disposed below the illumination light-generating structure. The illumination light-generating structure is enclosed by the top radiation-resistant element, the first radiation-resistant light-transmitting element, and the bottom radiation-resistant element to reduce radiation damage that the illumination light-generating structure may suffer in high-radiation environments.

### CROSS-REFERENCE TO RELATED PATENT APPLICATION

This application claims the benefit of priority to Taiwan Patent Application No. 114203641, filed on Apr. 14, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a lighting module, and more particularly to a radiation-resistant light-emitting diode (LED) lamp module.

### BACKGROUND OF THE DISCLOSURE

In the related art, the LED lamps are susceptible to radiation damage in high-radiation environments, which presents room for improvement.

### SUMMARY OF THE DISCLOSURE

In response to the above-referenced technical inadequacy, the present disclosure provides a radiation-resistant LED lamp module.

In order to solve the above-mentioned problems, one of the technical aspects adopted by the present disclosure is to provide a radiation-resistant LED lamp module, which includes at least one illumination light-generating structure, at least one top radiation-resistant structure, at least one radiation-resistant light-transmitting structure and at least one bottom radiation-resistant structure. The at least one illumination light-generating structure includes a circuit substrate and a plurality of LED elements disposed on the circuit substrate. The at least one top radiation-resistant structure includes a top radiation-resistant element disposed above the at least one illumination light-generating structure. The at least one radiation-resistant light-transmitting structure includes a first radiation-resistant light-transmitting element disposed above the at least one illumination light-generating structure, and a second radiation-resistant light-transmitting element disposed above the first radiation-resistant light-transmitting element. The at least one bottom radiation-resistant structure includes a bottom radiation-resistant element disposed below the at least one illumination light-generating structure. More particularly, the at least one radiation-resistant light-transmitting structure is configured to be separate from the at least one illumination light-generating structure, and the at least one bottom radiation-resistant structure is configured to contact the circuit substrate of the at least one illumination light-generating structure. The first radiation-resistant light-transmitting element is configured as one of a first lead-containing light-transmitting element and a first boron-containing light-transmitting element that is detachably disposed above the at least one illumination light-generating structure, and the second radiation-resistant light-transmitting element is configured as one of a second lead-containing light-transmitting element and a second boron-containing light-transmitting element that is detachably disposed above the at least one illumination light-generating structure. The at least one illumination light-generating structure is enclosed by the top radiation-resistant element, the first radiation-resistant light-transmitting element, and the bottom radiation-resistant element.

In order to solve the above-mentioned problems, another one of the technical aspects adopted by the present disclosure is to provide a radiation-resistant LED lamp module, which includes at least one illumination light-generating structure, at least one top radiation-resistant structure, at least one radiation-resistant light-transmitting structure and at least one bottom radiation-resistant structure. The at least one illumination light-generating structure includes a circuit substrate and a plurality of LED elements disposed on the circuit substrate. The at least one top radiation-resistant structure includes a top radiation-resistant element disposed above the at least one illumination light-generating structure. The at least one radiation-resistant light-transmitting structure includes a first radiation-resistant light-transmitting element disposed above the at least one illumination light-generating structure, and a second radiation-resistant light-transmitting element disposed above the first radiation-resistant light-transmitting element. The at least one bottom radiation-resistant structure includes a bottom radiation-resistant element disposed below the at least one illumination light-generating structure. More particularly, the first radiation-resistant light-transmitting element is configured as one of a first lead-containing light-transmitting element and a first boron-containing light-transmitting element that is detachably disposed above the at least one illumination light-generating structure, and the second radiation-resistant light-transmitting element is configured as one of a second lead-containing light-transmitting element and a second boron-containing light-transmitting element that is detachably disposed above the at least one illumination light-generating structure.

In order to solve the above-mentioned problems, yet another one of the technical aspects adopted by the present disclosure is to provide a radiation-resistant LED lamp module, which includes at least one illumination light-generating structure, at least one top radiation-resistant structure, at least one radiation-resistant light-transmitting structure and at least one bottom radiation-resistant structure. The at least one illumination light-generating structure includes a circuit substrate and a plurality of LED elements disposed on the circuit substrate. The at least one top radiation-resistant structure includes a top radiation-resistant element disposed above the at least one illumination light-generating structure. The at least one radiation-resistant light-transmitting structure includes a first radiation-resistant light-transmitting element disposed above the at least one illumination light-generating structure, and a second radiation-resistant light-transmitting element disposed above the first radiation-resistant light-transmitting element. The at least one bottom radiation-resistant structure includes a bottom radiation-resistant element disposed below the at least one illumination light-generating structure. More particularly, the at least one illumination light-generating structure is enclosed by the top radiation-resistant element, the first radiation-resistant light-transmitting element, and the bottom radiation-resistant element.

Therefore, in the radiation-resistant LED lamp module provided by the present disclosure, by virtue of “the at least one top radiation-resistant structure including a top radiation-resistant element disposed above the at least one illumination light-generating structure,” “the at least one radiation-resistant light-transmitting structure including a first radiation-resistant light-transmitting element disposed above the at least one illumination light-generating structure, and a second radiation-resistant light-transmitting element disposed above the first radiation-resistant light-transmitting element” and “the at least one bottom radiation-resistant structure including a bottom radiation-resistant element disposed below the at least one illumination light-generating structure,” the radiation damage that the at least one illumination light-generating structure may suffer in a high-radiation environment can be effectively reduced.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded perspective view of a radiation-resistant LED lamp module according to a first embodiment of the present disclosure;

FIG. 2 is a schematic exploded perspective view of a portion of the radiation-resistant LED lamp module according to the first embodiment of the present disclosure;

FIG. 3 is a schematic exploded perspective view of another portion of the radiation-resistant LED lamp module according to the first embodiment of the present disclosure;

FIG. 4 is a schematic assembled perspective view of the radiation-resistant LED lamp module according to the first embodiment of the present disclosure;

FIG. 5 is a schematic cross-sectional view taken along line V-V of FIG. 4;

FIG. 6 is a schematic enlarged view of part VI of FIG. 5;

FIG. 7 is a schematic diagram showing the mutual arrangement of a first radiation-resistant light-transmitting element and a second radiation-resistant light-transmitting element of at least one radiation-resistant light-transmitting structure according to the first embodiment of the present disclosure;

FIG. 8 is a schematic diagram showing the radiation-resistant LED lamp module configured to be detachably and movably mounted on a ceiling support structure according to the first embodiment of the present disclosure;

FIG. 9 is a schematic diagram showing the mutual configuration of the first and second radiation-resistant light-transmitting elements of the at least one radiation-resistant light-transmitting structure according to a second embodiment of the present disclosure;

FIG. 10 is a schematic diagram showing the mutual configuration of the first and second radiation-resistant light-transmitting elements of the at least one radiation-resistant light-transmitting structure according to a third embodiment of the present disclosure; and

FIG. 11 is a schematic assembled perspective view of the radiation-resistant LED lamp module according to a fourth embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like. It should be noted that the examples described below are merely one feasible embodiment and are not intended to limit the scope of the present disclosure.

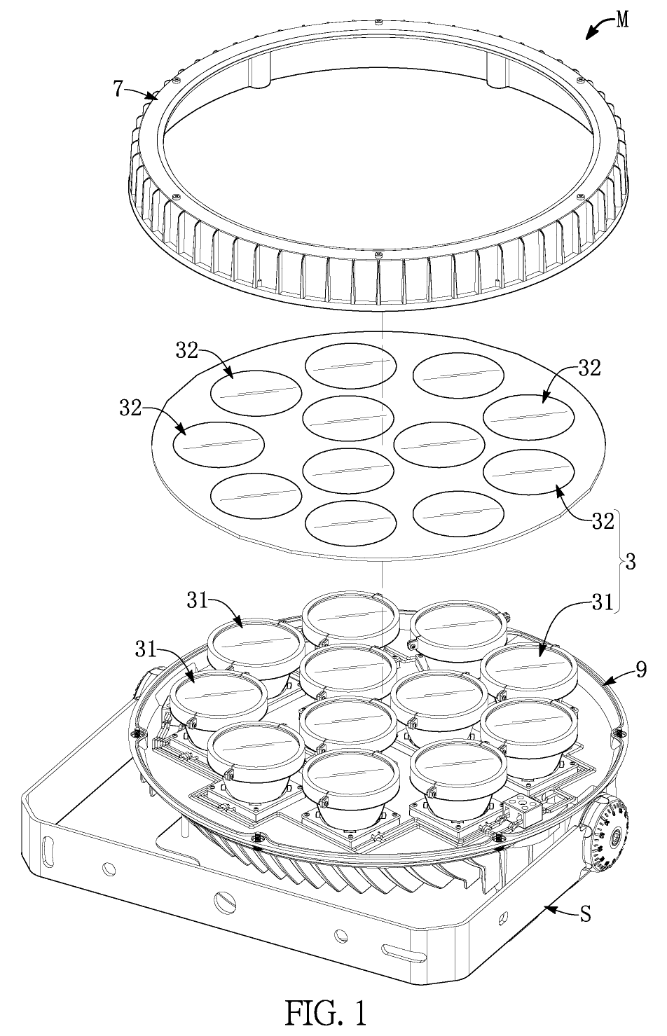

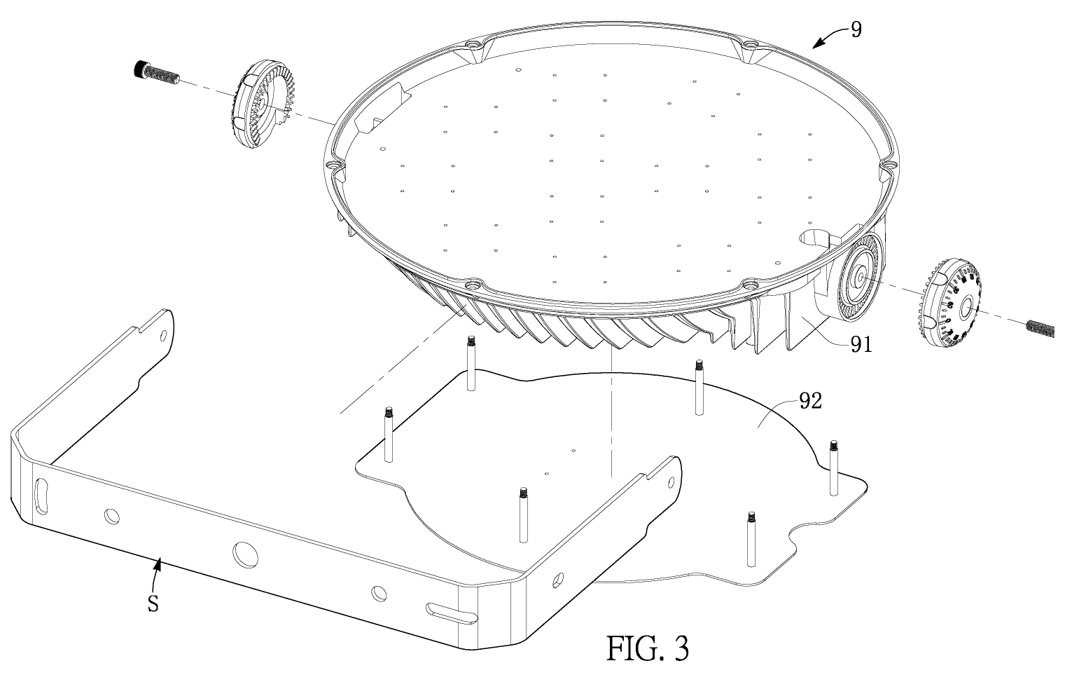

Referring to FIGS. 1 to 10, the present disclosure provides a radiation-resistant LED lamp module M (or a radiation-hardened LED lamp module, or a radiation-shielding LED lamp module), which may include at least one illumination light-generating structure 1, at least one top radiation-resistant structure 2, at least one radiation-resistant light-transmitting structure 3, and at least one bottom radiation-resistant structure 4. More specifically, the at least one illumination light-generating structure 1 may include at least one circuit substrate 10 and a plurality of LED elements 11 disposed on the circuit substrate 10, and the at least one top radiation-resistant structure 2 may include at least one top radiation-resistant element 20 disposed above the at least one illumination light-generating structure 1. Furthermore, the at least one radiation-resistant light-transmitting structure 3 may include at least one first radiation-resistant light-transmitting element 31 disposed above the at least one illumination light-generating structure 1 (such as being detachably disposed on a reflector cup element 82) and a second radiation-resistant light-transmitting element 32 disposed above the first radiation-resistant light-transmitting element 31 (such as being detachably disposed on a lamp housing 91). In addition, the at least one bottom radiation-resistant structure 4 may include at least one bottom radiation-resistant element 40 disposed below the at least one illumination light-generating structure 1. It should be noted that the at least one illumination light-generating structure 1 can be enclosed or covered by the top radiation-resistant element 20, the first radiation-resistant light-transmitting element 31, and the bottom radiation-resistant element 40, thereby reducing radiation damage that the at least one illumination light-generating structure 1 may suffer in a high-radiation environment.

### First Embodiment

Referring to FIGS. 1 to 8, a first embodiment of the present disclosure provides a radiation-resistant LED lamp module M, which may include a plurality of illumination light-generating structures 1 (or light providing structures), a plurality of top radiation-resistant structures 2, a plurality of radiation-resistant light-transmitting structures 3, a plurality of bottom radiation-resistant structures 4, and a plurality of surrounding radiation-resistant structures 5.

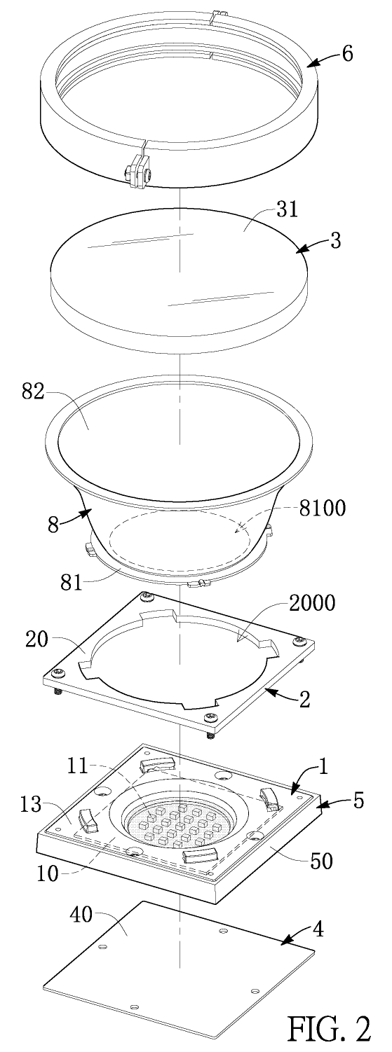

More particularly, referring to FIGS. 2, 5 and 6, each illumination light-generating structure 1 may include at least a circuit substrate 10 and a plurality of LED elements 11, and the LED elements 11 can be disposed on and electrically connected to the circuit substrate 10. For example, the LED elements 11 can be configured as a plurality of alternating current (AC) LED chips (e.g., each AC LED chip can be an unpackaged bare die or a packaged die, and each AC LED chip can be a COB (Chip on Board) type LED element), and the LED elements 11 can be encapsulated using silicone or epoxy. It should be noted that the at least one illumination light-generating structure 1 may further include a plurality of electronic components 12 and a radiation-resistant insulating cover 13. Furthermore, the electronic components 12 can be disposed on and electrically connected to the circuit substrate 10, and each of the electronic components 12 can be configured as one of the following: a capacitor (such as a conventional capacitor or a chip capacitor), an inductor (such as a conventional inductor or a chip inductor), a resistor (such as a conventional resistor or a chip resistor), a current limiting element (such as a conventional current limiter or a chip current limiter), and a rectifier (such as a conventional rectifier or a chip rectifier), or any type of electronic component or electronic chip. Additionally, the radiation-resistant insulating cover 13 can be disposed on the circuit substrate 10 to cover the electronic components 12, and the radiation-resistant insulating cover 13 can be configured as a titanium-containing insulating cover (such as a titanium-containing insulating package body that may include PBT and titanium dioxide) or a metal-containing insulating cover.

More particularly, referring to FIGS. 2, 5 and 6, each top radiation-resistant structure 2 may include at least one top radiation-resistant element 20, and the top radiation-resistant element 20 can be disposed above the at least one illumination light-generating structure 1. For example, the top radiation-resistant element 20 can be configured as a lead-containing surrounding cover (or a metal-containing surrounding cover), and the lead-containing surrounding cover can be detachably disposed (mounted) on the radiation-resistant insulating cover 13 of the at least one illumination light-generating structure 1 via a plurality of screws. In addition, the top radiation-resistant element 20 has a through opening 2000 for exposing the LED elements 11, and the through opening 2000 provided by the top radiation-resistant element 20 can correspondingly expose the LED elements 11. Furthermore, depending on different requirements, the thickness of the top radiation-resistant element 20 can be between 1000 μm and 5000 μm (such as any positive integer between 1000 μm and 5000 μm).

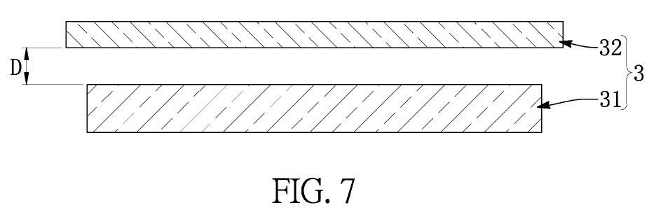

More particularly, referring to FIGS. 1, 2, 5 and 6, each radiation-resistant light-transmitting structure 3 may include at least a first radiation-resistant light-transmitting element 31 and a second radiation-resistant light-transmitting element 32. The first radiation-resistant light-transmitting element 31 can be disposed above the at least one illumination light-generating structure 1, and the second radiation-resistant light-transmitting element 32 can be disposed above the first radiation-resistant light-transmitting element 31. For example, each radiation-resistant light-transmitting structure 3 can be configured to be separate from the at least one illumination light-generating structure 1 by a predetermined distance, and the first radiation-resistant light-transmitting element 31 and the second radiation-resistant light-transmitting element 32 can be configured to be separate from each other by a predetermined distance D (as shown in FIG. 7). Furthermore, the first radiation-resistant light-transmitting element 31 can be configured as a first lead-containing light-transmitting element (or a metal-containing light-transmitting element), a first boron-containing light-transmitting element (or a non-metal-containing light-transmitting element), or a first silicon-containing light-transmitting element (such as a first quartz glass) detachably disposed above the at least one illumination light-generating structure 1, and the second radiation-resistant light-transmitting element 32 can be configured as a second lead-containing light-transmitting element (or a metal-containing light-transmitting element), a second boron-containing light-transmitting element (or a non-metal-containing light-transmitting element), or a second silicon-containing light-transmitting element (such as a second quartz glass) detachably disposed above the at least one illumination light-generating structure 1. Additionally, the first radiation-resistant light-transmitting element 31 can be configured as a first radiation-resistant light-transmitting plate without through holes (or a first non-perforated radiation-resistant light-transmitting plate), and the second radiation-resistant light-transmitting element 32 can be configured as a second radiation-resistant light-transmitting plate without through holes (or a second non-perforated radiation-resistant light-transmitting plate). Moreover, depending on different requirements, the thickness of the first radiation-resistant light-transmitting element 31 can be between 1000 μm and 5000 μm (such as any positive integer between 1000 μm and 5000 μm), and the thickness of the second radiation-resistant light-transmitting element 32 can be between 1000 μm and 5000 μm (such as any positive integer between 1000 μm and 5000 μm). It should be noted that the first radiation-resistant light-transmitting element 31 can be detachably disposed above the at least one illumination light-generating structure 1 and can be limited or secured by at least one first position-limiting structure 6, and the second radiation-resistant light-transmitting element 32 can be detachably disposed above the first radiation-resistant light-transmitting element 31 and can be limited or secured by a second position-limiting structure 7. It is also worth noting that the second radiation-resistant light-transmitting elements 32 can be disposed on the same light-transmitting or opaque substrate to form a single optical component.

More particularly, referring to FIGS. 2, 5 and 6, each bottom radiation-resistant structure 4 may include at least one bottom radiation-resistant element 40, and the bottom radiation-resistant element 40 can be disposed below the at least one illumination light-generating structure 1. For example, each bottom radiation-resistant structure 4 can be configured to (directly or indirectly) contact the circuit substrate 10 of the at least one illumination light-generating structure 1. In addition, the bottom radiation-resistant element 40 can be configured as a radiation-resistant heat dissipation element (or a metal heat dissipation element), and the radiation-resistant heat dissipation element can be detachably and directly (or indirectly) contact the circuit substrate 10. Furthermore, depending on different requirements, the thickness of the bottom radiation-resistant element 40 can be between 1000 μm and 5000 μm (such as any positive integer between 1000 μm and 5000 μm).

More particularly, referring to FIGS. 2, 5 and 6, each surrounding radiation-resistant structure 5 may include at least one surrounding radiation-resistant element 50, and the surrounding radiation-resistant element 50 can be disposed around the at least one illumination light-generating structure 1. For example, the surrounding radiation-resistant element 50 can be configured as a tungsten-containing surrounding cover (or a metal-containing surrounding cover), and the tungsten-containing surrounding cover can detachably surround the at least one illumination light-generating structure 1, or the tungsten-containing surrounding cover can also detachably surround the top radiation-resistant element 20 and the bottom radiation-resistant element 40. In addition, depending on different requirements, the thickness of the surrounding radiation-resistant element 50 can be between 1000 μm and 5000 μm (such as any positive integer between 1000 μm and 5000 μm). It should be noted that the surrounding radiation-resistant element 50 may be a complete and continuous surrounding element, or the surrounding radiation-resistant element 50 may also have a slot or a groove for wires to pass through, or the surrounding radiation-resistant element 50 can be omitted in the first embodiment of the present disclosure.

It should be noted that, for example, referring to FIGS. 2, 5, 6 and 7, when the first radiation-resistant light-transmitting element 31 and the second radiation-resistant light-transmitting element 32 can be configured to be separate from each other by a predetermined distance D (that is to say, the first radiation-resistant light-transmitting element 31 and the second radiation-resistant light-transmitting element 32 can be two independent optical components), the radiation-resistant LED lamp module M may further include a plurality of light reflector structures 8, and each light reflector structure 8 can be disposed between the radiation-resistant insulating cover 13 of the at least one illumination light-generating structure 1 and the first radiation-resistant light-transmitting element 31. Furthermore, each light reflector structure 8 may include at least a support base 81 (or a support substrate) and a reflector cup element 82 (or an integrally formed metal reflector, or a one-piece metal reflector). The support base 81 can be disposed on the radiation-resistant insulating cover 13 of the at least one illumination light-generating structure 1. The support base 81 has a through opening 8100 for exposing the LED elements 11. The reflector cup element 82 can be connected to the support base 81 in a surrounding manner, and the reflector cup element 82 has a reflective coating or a reflective structure additionally formed on the inner surface thereof, or the reflector cup element 82 itself can be made of reflective material. In addition, the radiation-resistant insulating cover 13 can be configured to support the support base 81, and the support base 81 can be configured to support the first radiation-resistant light-transmitting element 31. It should be noted that, in one feasible embodiment, when the first radiation-resistant light-transmitting element 31 can be configured as a first lead-containing light-transmitting element, the first lead-containing light-transmitting element can be configured as a first lead-containing glass plate or a first lead-containing plastic plate. In one feasible embodiment, when the first radiation-resistant light-transmitting element 31 can be configured as a first boron-containing light-transmitting element, the first boron-containing light-transmitting element can be configured as a first boron-containing glass plate or a first boron-containing plastic plate.

It should be noted that, for example, referring to FIGS. 1, 3, 5 and 6, the radiation-resistant LED lamp module M may further include a radiation-resistant lamp support structure 9, and the radiation-resistant lamp support structure 9 may include a lamp housing 91, a stainless steel support base 92, a graphite substrate (not shown), and an aluminum substrate (not shown). The stainless steel support base 92 can be detachably disposed on the lamp housing 91, the graphite substrate can be detachably disposed within the lamp housing 91, the aluminum substrate can be detachably disposed on the graphite substrate, and the aluminum substrate can be configured to support the bottom radiation-resistant element 40 and the surrounding radiation-resistant elements 50. Furthermore, depending on different requirements, the thickness of the stainless steel support 92 can be between 1000 μm and 5000 μm (such as any positive integer between 1000 μm and 5000 μm), the thickness of the graphite substrate can be between 1000 μm and 5000 μm (such as any positive integer between 1000 μm and 5000 μm), and the thickness of the aluminum substrate can be between 3000 μm and 7000 μm (such as any positive integer between 3000 μm and 7000 μm). It should be noted that, in one feasible embodiment, when the second radiation-resistant light-transmitting element 32 can be configured as a second lead-containing light-transmitting element, the second lead-containing light-transmitting element can be configured as one of a second lead-containing glass plate and a second lead-containing plastic plate. In one feasible embodiment, when the second radiation-resistant light-transmitting element 32 can be configured as a second boron-containing light-transmitting element, the second boron-containing light-transmitting element can be configured as one of a second boron-containing glass plate and a second boron-containing plastic plate.

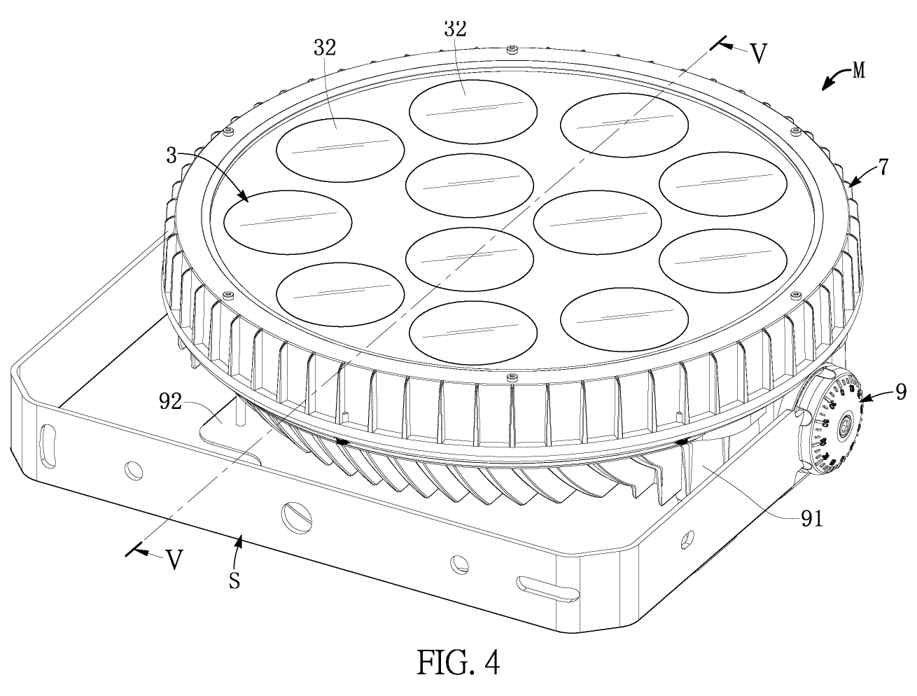

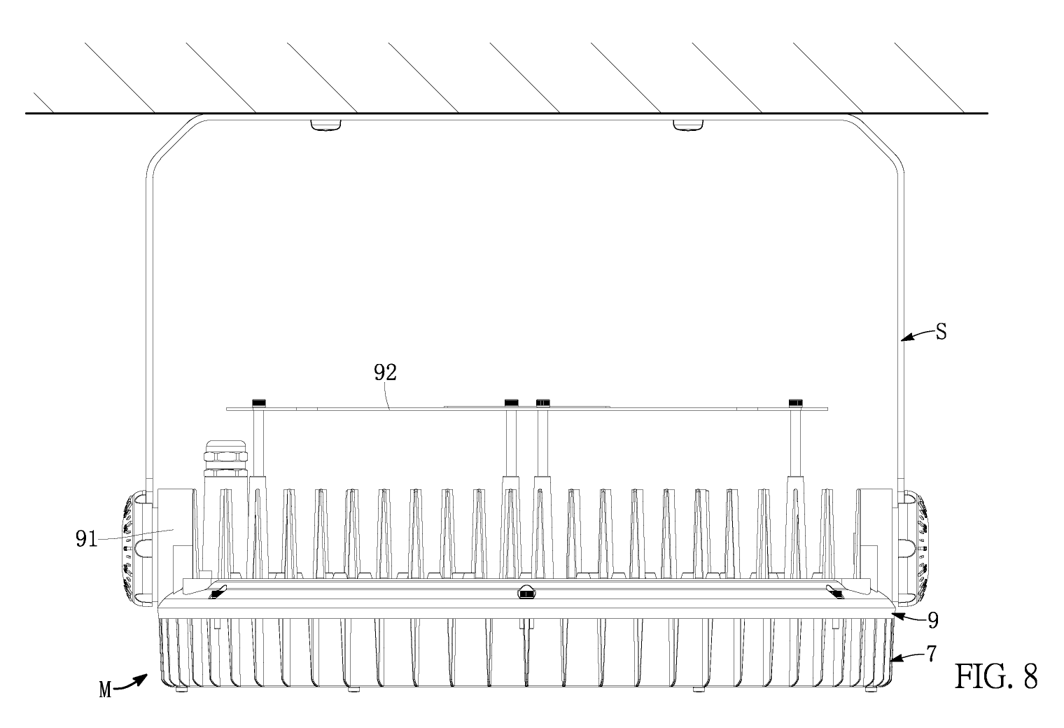

It should be noted that, for example, referring to FIGS. 4 and 8, the lamp housing 91 can be configured to be detachably and movably disposed (mounted) on a ceiling support structure S, so that the placement angle of the radiation-resistant LED lamp module M can be adjusted relative to the ceiling support structure S. Therefore, in one feasible embodiment, when the radiation-resistant LED luminaire module M is installed through the ceiling support structure S in a high-radiation environment (such as in an electromagnetic wave environment with X-rays or gamma rays, or in a particle radiation environment with alpha rays, beta rays, or neutron radiation), the at least one illumination light-generating structure 1 can be enclosed or covered by the top radiation-resistant element 20, the first radiation-resistant light-transmitting element 31, the bottom radiation-resistant element 40, and the surrounding radiation-resistant elements 50 (or further supplemented by the radiation-resistant assistance of the second radiation-resistant light-transmitting element 32, the light reflector structure 8, and the radiation-resistant lamp support structure 9), so that the radiation damage that the at least one illumination light-generating structure 1 may suffer in a high-radiation environment can be effectively reduced.

It should be noted that, for example, referring to FIGS. 1, 4 and 8, an outer surrounding area of the second radiation-resistant light-transmitting element 32 (i.e., the light-transmitting or opaque substrate for supporting the second radiation-resistant light-transmitting elements 32) can be configured to provide information about radiation resistance levels (for example, different colors or patterns can be used to represent different levels of radiation absorbed dose, thereby enhancing the product grade identifiability of the radiation-resistant LED lamp module M). Therefore, even when the radiation-resistant LED lamp module M is installed in a high-radiation environment via the ceiling support structure S, the user can still obtain or understand the radiation resistance level of the radiation-resistant LED lamp module M through the information about radiation resistance levels (e.g., the radiation absorption dose can be 156 kGy or 312 kGy) provided by the outer surrounding area of the second radiation-resistant light-transmitting element 32 (i.e., the light-transmitting or opaque substrate for supporting the second radiation-resistant light-transmitting elements 32).

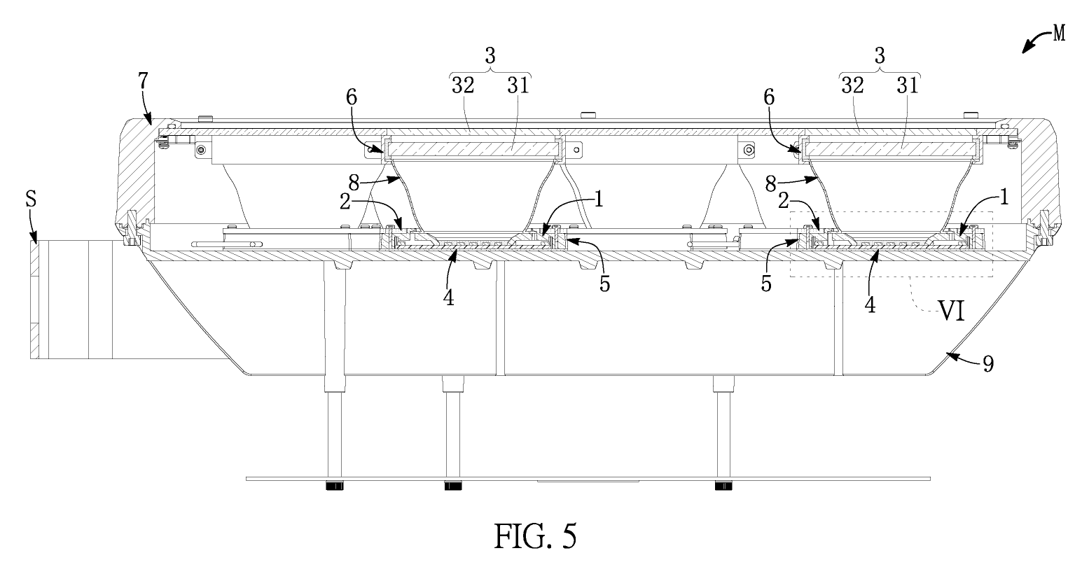

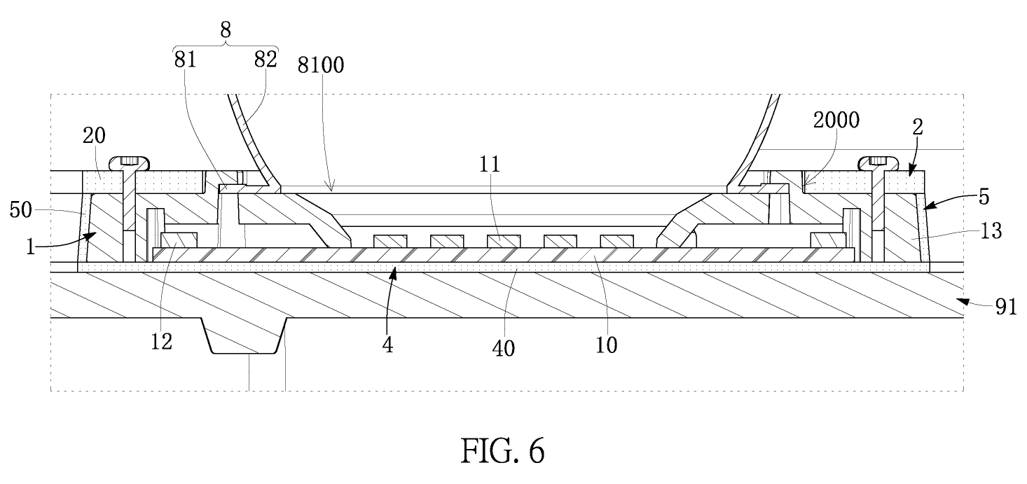

It should be noted that, for example, referring to FIGS. 5 and 6, the vertical projection of each LED element 11 can fall completely on the first radiation-resistant light-transmitting element 31 and the bottom radiation-resistant structure 4 (that is to say, the LED elements 11 can be simultaneously and correspondingly disposed between the first radiation-resistant light-transmitting element 31 and the bottom radiation-resistant structure 4, and the horizontal distribution area of the LED elements 11 can be smaller than the horizontal distribution area of the first radiation-resistant light-transmitting element 31 or the horizontal distribution area of the bottom radiation-resistant structure 4), and the vertical projection of each electronic component 12 can fall completely on the top radiation-resistant element 20 and the bottom radiation-resistant structure 4 (that is to say, the electronic components 12 can be simultaneously and correspondingly disposed between the top radiation-resistant element 20 and the bottom radiation-resistant structure 4, and the horizontal distribution area of the electronic components 12 can be smaller than the horizontal distribution area of the top radiation-resistant element 20 or the horizontal distribution area of the bottom radiation-resistant structure 4).

It should be noted that, for example, referring to FIGS. 5, 6 and 8, when the anti-radiation LED lamp module M is installed in a high-radiation environment through the ceiling support structure S, and the LED elements 11 can be configured to generate illumination beams (or provide a light source), the illumination beams generated by the LED elements 11 can sequentially pass through the through opening 2000 of the top anti-radiation element 20, the through opening 8100 of the support base 81, the first anti-radiation light-transmitting element 31, and the second anti-radiation light-transmitting element 32, thereby providing the user with the required lighting source.

### Second Embodiment

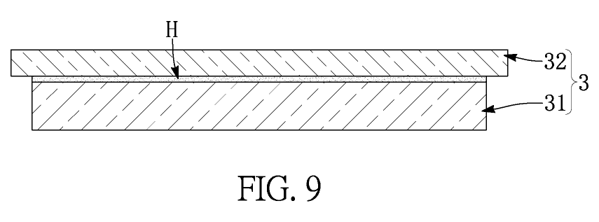

Referring to FIG. 9, a second embodiment of the present disclosure provides a plurality of anti-radiation light-transmitting structures 3, which can be applied to an anti-radiation LED lamp module. Comparing FIGS. 9 with 7, the main difference between the second embodiment and the first embodiment is as follows: in the second embodiment, the second radiation-resistant light-transmitting element 32 can be positioned on the first radiation-resistant light-transmitting element 31 through an adhesive layer H. Therefore, the first radiation-resistant light-transmitting element 31 and the second radiation-resistant light-transmitting element 32 can be combined into a single optical component through the adhesive layer H. For example, depending on different needs, the radiation-resistant LED lamp module can selectively adopt the radiation-resistant light-transmitting structures 3 provided by the first embodiment (as shown in FIG. 7) or the radiation-resistant light-transmitting structures 3 provided by the second embodiment (as shown in FIG. 9).

### Third Embodiment

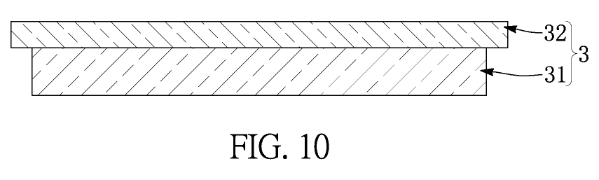

Referring to FIG. 10, a third embodiment of the present disclosure provides a plurality of radiation-resistant light-transmitting structures 3, which can be applied to a radiation-resistant LED lamp module. Comparing FIGS. 10 with 7 (or comparing FIGS. 10 with 9), the main difference between the third embodiment and the first embodiment (or the second embodiment) is as follows: in the third embodiment, the first radiation-resistant light-transmitting element 31 and the second radiation-resistant light-transmitting element 32 can be configured to be stacked on top of each other or in direct contact with each other (that is to say, the first radiation-resistant light-transmitting element 31 and the second radiation-resistant light-transmitting element 32 can be two independent optical components). For example, depending on different needs, the radiation-resistant LED lamp module can selectively adopt the radiation-resistant light-transmitting structures 3 provided by the first embodiment (as shown in FIG. 7), the radiation-resistant light-transmitting structures 3 provided by the second embodiment (as shown in FIG. 9), or the radiation-resistant light-transmitting structures 3 provided by the third embodiment (as shown in FIG. 10).

### Fourth Embodiment

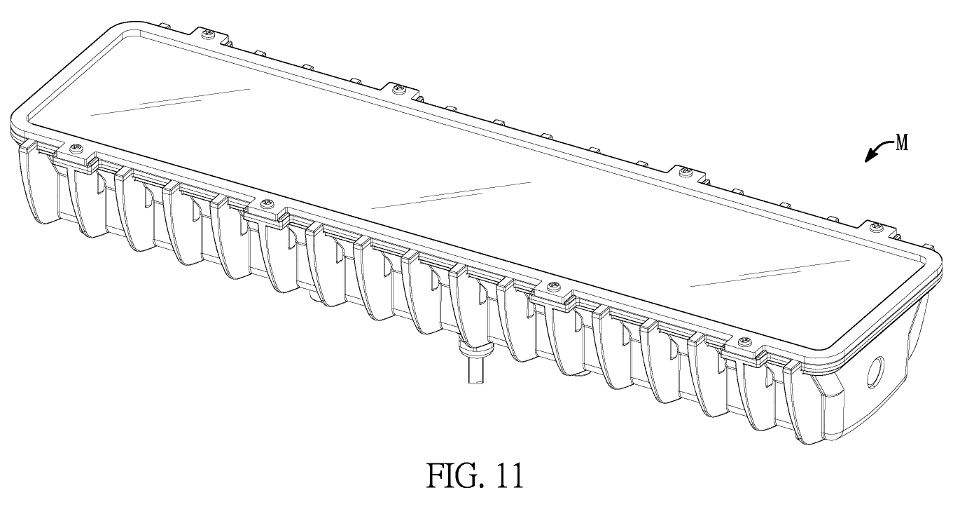

Referring to FIG. 11, a fourth embodiment of the present disclosure provides a radiation-resistant LED lamp module M (or a radiation-proof LED lamp module). Comparing FIGS. 11 with 4, the main difference between the fourth embodiment and the first embodiment is as follows: in the fourth embodiment, the shape of the radiation-resistant LED lamp module M can also be replaced with a long strip-shaped LED lamp module. That is to say, depending on different requirements, the present disclosure can select either a disc-shaped or long strip-shaped radiation-resistant LED lamp module M.

### Beneficial Effects of the Embodiments

In conclusion, in the radiation-resistant LED lamp module M provided by the present disclosure, by virtue of “the at least one top radiation-resistant structure 2 including a top radiation-resistant element 20 disposed above the at least one illumination light-generating structure 1,” “the at least one radiation-resistant light-transmitting structure 3 including a first radiation-resistant light-transmitting element 31 disposed above the at least one illumination light-generating structure 1, and a second radiation-resistant light-transmitting element 32 disposed above the first radiation-resistant light-transmitting element 31” and “the at least one bottom radiation-resistant structure 4 including a bottom radiation-resistant element 40 disposed below the at least one illumination light-generating structure 1,” the radiation damage that the at least one illumination light-generating structure 1 may suffer in a high-radiation environment can be effectively reduced.

It should be noted that, for example, the illumination light-generating structure 1, the top radiation-resistant structure 2, the radiation-resistant light-transmitting structure 3, the bottom radiation-resistant structure 4, the surrounding radiation-resistant structure 5, the light reflector structure 8, and the radiation-resistant lamp support structure 9 can all be made of materials consisting of low atomic number elements or stable isotopes (for example, the main material can be selected from the group composed of Fe, Cr, W, V, Ti, Si, and C, or the main material that do not contain Ni, Co, Cu, Nb, Ag, Mo-Re, Eu, etc., which are prone to producing long-lived nuclei). Furthermore, the illumination light-generating structure 1, the top radiation-resistant structure 2, the radiation-resistant light-transmitting structure 3, the bottom radiation-resistant structure 4, the surrounding radiation-resistant structure 5, the light reflector structure 8, and the radiation-resistant lamp support structure 9 can all be interconnected through a plurality of locking elements (such as screws or bolts), without using any welding methods (non-welding assembly method). Moreover, the illumination light-generating structure 1, the top radiation-resistant structure 2, the radiation-resistant light-transmitting structure 3, the bottom radiation-resistant structure 4, the surrounding radiation-resistant structure 5, the light reflector structure 8, and the radiation-resistant lamp support structure 9 can all be made of high-temperature resistant materials suitable for temperatures below 150°C.

It should be noted that the internal or enclosed space of the radiation-resistant LED lamp module M provided by the present disclosure can be equipped with a low-temperature activation zirconium-based getter and a high-efficiency molecular sieve desiccant. The low-temperature activation zirconium-based getter is responsible for long-term degassing (providing a low-oxygen environment), and the high-efficiency molecular sieve desiccant is responsible for rapid dehumidification (providing a low-humidity environment), thereby improving the reliability and lifespan of the radiation-resistant LED lamp module M. Additionally, the circuit substrate 10 can be configured as a ceramic substrate or a metal core printed circuit board (MCPCB).

It should be noted that the radiation-resistant LED lamp module M provided by the present disclosure also has the following characteristics:

I. Radiation-Resistant Encapsulation Material Combination: The present disclosure provides a radiation-resistant LED lamp module M including a radiation-resistant optical protection layer formed from a combination of materials selected to withstand high-dose radiation exposure. The radiation-resistant LED lamp module M is configured to operate under cumulative radiation doses of approximately 300 to 800 kGy, and up to approximately 1 MGy. The radiation-resistant optical protection layer includes: (1) Radiation-Resistant Silicone Encapsulation Layer: A silicone encapsulation layer is disposed to encapsulate at least one AC SMD LED chip. The silicone encapsulation layer includes a silicone material having an increased cross-linking density and phenyl functional groups, in which the molecular structure is configured to reduce degradation induced by gamma radiation and neutron irradiation. The silicone encapsulation layer is configured to withstand a total radiation dose of approximately 500 to 800 kGy without exhibiting substantial yellowing, cracking, or mechanical failure. (2) Fused Silica Protective Layer: A fused silica protective layer is disposed between the AC SMD LED chip and an external radiation environment. The fused silica protective layer has a thickness of approximately 200 to 800 μm and is configured to suppress radiation-induced optical darkening and to reduce degradation of optical transmittance under gamma radiation exposure. In some embodiments, the radiation-resistant LED lamp module M further includes a ceramic substrate formed of Al₂O₃ or AlN, in combination with a BT resin having radiation stability. The ceramic substrate and BT resin are configured to support solder joints, gold wires, and die interconnection regions, in which the solder joints and interconnection regions maintain structural integrity under a cumulative radiation dose of up to approximately 1 MGy.

II. Failure-Resistant Architecture with Multi-Series-Parallel Segmented Current Paths: The present disclosure further provides a current path architecture configured to mitigate functional failure in gamma and neutron radiation environments, in which an increased probability of individual die failure is present. The current path architecture includes: (1) Multi-Loop Segmented Current Paths: A plurality of LED chips (dies) are electrically divided into multiple current loops that are independent or partially coupled. Each current loop is configured such that failure of one LED chip does not interrupt current flow through other current loops. (2) Linear Voltage Divider Multi-Series-Parallel AC SMD Structure: The LED chips are arranged in a multi-series-parallel configuration in combination with a linear voltage divider, in which interruption of a single current loop does not cause complete electrical failure of the radiation-resistant LED lamp module. (3) Graceful Degradation Light Output Configuration: The radiation-resistant LED lamp module M is configured such that, upon failure of a single LED chip, a remaining portion of the LED chips continues to emit light, thereby maintaining approximately 80% to 90% of an initial luminous flux.

III. Light Maintenance Performance in High-Radiation Environments: The radiation-resistant LED lamp module M is configured to maintain a light maintenance value of L70≥70% under a cumulative radiation dose of approximately 300 to 800 kGy across an operating temperature range of approximately −80°C to +145°C.

IV. Radiation-Resistant Quartz Glass Structure: In some embodiments, the radiation-resistant LED lamp module M further includes an optical window including a radiation-resistant quartz glass structure. The quartz glass structure includes: (1) Thick-Layer Quartz Glass: A fused quartz glass layer having a thickness of approximately 5 mm is disposed at an optical output end of the radiation-resistant LED lamp module and is configured to reduce radiation-induced optical darkening caused by high-energy photon irradiation. (2) Ultra-Low Impurity Quartz Composition: The fused quartz glass includes transition metal impurities, including iron (Fe) and copper (Cu), at concentrations of less than approximately 1 ppm, in which the reduced impurity concentration suppresses formation of radiation-induced color centers during high-dose radiation exposure.

V. Neutron Irradiation Reliability: The radiation-resistant LED lamp module M has been subjected to neutron irradiation testing. The radiation-resistant LED lamp module M maintains operational functionality under cumulative neutron fluences of approximately 1×10¹³ n/cm², 5×10¹³ n/cm², and 1×10¹⁴ n/cm², without exhibiting substantial luminous flux degradation, structural damage, or electrical failure. Packaging materials, optoelectronic components, and metallic structures of the radiation-resistant LED lamp module M are configured to tolerate displacement damage associated with neutron irradiation.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A radiation-resistant LED lamp module, comprising:
at least one illumination light-generating structure including a circuit substrate and a plurality of LED elements disposed on the circuit substrate;
at least one top radiation-resistant structure including a top radiation-resistant element disposed above the at least one illumination light-generating structure;
at least one radiation-resistant light-transmitting structure including a first radiation-resistant light-transmitting element disposed above the at least one illumination light-generating structure, and a second radiation-resistant light-transmitting element disposed above the first radiation-resistant light-transmitting element; and
at least one bottom radiation-resistant structure including a bottom radiation-resistant element disposed below the at least one illumination light-generating structure;
wherein the at least one radiation-resistant light-transmitting structure is configured to be separate from the at least one illumination light-generating structure, and the at least one bottom radiation-resistant structure is configured to contact the circuit substrate of the at least one illumination light-generating structure;
wherein the first radiation-resistant light-transmitting element is configured as one of a first lead-containing light-transmitting element and a first boron-containing light-transmitting element that is detachably disposed above the at least one illumination light-generating structure, and the second radiation-resistant light-transmitting element is configured as one of a second lead-containing light-transmitting element and a second boron-containing light-transmitting element that is detachably disposed above the at least one illumination light-generating structure; and
wherein the at least one illumination light-generating structure is enclosed by the top radiation-resistant element, the first radiation-resistant light-transmitting element, and the bottom radiation-resistant element.

2. The radiation-resistant LED lamp module according to claim 1,
wherein the at least one illumination-generating structure further includes a plurality of electronic components disposed on the circuit substrate and a radiation-resistant insulating cover disposed on the circuit substrate to cover the electronic components;
wherein the circuit substrate is configured as a ceramic substrate or a metal core printed circuit board;
wherein each of the LED elements is configured as an AC LED chip, each of the electronic components is configured as one of a capacitor, an inductor, a resistor, a current-limiting element, and a rectifier, and the radiation-resistant insulating cover is configured as a titanium-containing insulating cover;
wherein a vertical projection of each of the LED elements falls entirely on the first radiation-resistant light-transmitting element and the at least one bottom radiation-resistant structure, and a vertical projection of each of the electronic components falls entirely on the top radiation-resistant element and the at least one bottom radiation-resistant structure;
wherein, when the first radiation-resistant light-transmitting element is configured as the first lead-containing light-transmitting element, the first lead-containing light-transmitting element is configured as one of a first lead-containing glass plate and a first lead-containing plastic plate;
wherein, when the first radiation-resistant light-transmitting element is configured as the first boron-containing light-transmitting element, the first boron-containing light-transmitting element is configured as one of a first boron-containing glass plate and a first boron-containing plastic plate;
wherein, when the second radiation-resistant light-transmitting element is configured as the second lead-containing light-transmitting element, the second lead-containing light-transmitting element is configured as one of a second lead-containing glass plate and a second lead-containing plastic plate;
wherein, when the second radiation-resistant light-transmitting element is configured as the second boron-containing light-transmitting element, the second boron-containing light-transmitting element is configured as one of a second boron-containing glass plate and a second boron-containing plastic plate;
wherein the first radiation-resistant light-transmitting element is configured as a first radiation-resistant light-transmitting plate without through holes, and the second radiation-resistant light-transmitting element is configured as a second radiation-resistant light-transmitting plate without through holes;
wherein the first radiation-resistant light-transmitting element is detachably disposed above the at least one illumination light-generating structure through at least one first position-limiting structure, and the second radiation-resistant light-transmitting element is detachably disposed above the first radiation-resistant light-transmitting element through a second position-limiting structure; and
wherein the second radiation-resistant light-transmitting element has an outer surrounding region that is configured to provide information about radiation resistance levels.

3. The radiation-resistant LED lamp module according to claim 1,
wherein the first radiation-resistant light-transmitting element and the second radiation-resistant light-transmitting element are configured to be separate from each other by a predetermined distance or stacked on top of each other;
wherein, when the first radiation-resistant light-transmitting element and the second radiation-resistant light-transmitting element are configured to be separate from each other by the predetermined distance, the radiation-resistant LED lamp module further comprises: at least one light reflector structure disposed between the at least one illumination light-generating structure and the first radiation-resistant light-transmitting element;
wherein the at least one light reflector structure includes a support base disposed on the at least one illumination light-generating structure and a reflector cup element surroundingly connected to the support base;
wherein the reflector cup element is configured to support the first radiation-resistant light-transmitting element;
wherein the top radiation-resistant element has a through opening for exposing the LED elements, and the support base has a through opening for exposing the LED elements;
wherein, when the LED elements are configured to generate an illumination beam, the illumination beam generated by the LED elements sequentially passes through the through opening of the top radiation-resistant element, the through opening of the support base, the first radiation-resistant light-transmitting element, and the second radiation-resistant light-transmitting element;
wherein the at least one illumination light-generating structure, the at least one top radiation-resistant structure, the at least one radiation-resistant light-transmitting structure, the at least one bottom radiation-resistant structure, and the at least one light reflector structure are all made of materials consisting of low atomic number elements or stable isotopes;
wherein the at least one illumination light-generating structure, the at least one top radiation-resistant structure, the at least one radiation-resistant light-transmitting structure, the at least one bottom radiation-resistant structure, and the at least one light reflector structure are all interconnected through a plurality of locking elements without welding; and
wherein the at least one illumination light-generating structure, the at least one top radiation-resistant structure, the at least one radiation-resistant light-transmitting structure, the at least one bottom radiation-resistant structure, and the at least one light reflector structure are all made of high-temperature resistant materials suitable for temperatures below 150° C.

4. The radiation-resistant LED lamp module according to claim 1,
wherein the radiation-resistant LED lamp module further comprises: a radiation-resistant lamp support structure including a lamp housing and a stainless steel support base detachably disposed on the lamp housing;
wherein the lamp housing is configured to be detachably and movably disposed on a ceiling support structure;
wherein the top radiation-resistant element is configured as a lead-containing surrounding cover plate detachably disposed on the at least one illumination light-generating structure, and the bottom radiation-resistant element is configured as a radiation-resistant heat dissipation element detachably contacting the circuit substrate;
wherein a thickness of the top radiation-resistant element is between 1000 μm and 5000 μm, a thickness of the first radiation-resistant light-transmitting element is between 1000 μm and 5000 μm, a thickness of the second radiation-resistant light-transmitting element is between 1000 μm and 5000 μm, a thickness of the bottom radiation-resistant element is between 1000 μm and 5000 μm, and a thickness of the stainless steel support base is between 1000 μm and 5000 μm;
wherein the at least one illumination light-generating structure, the at least one top radiation-resistant structure, the at least one radiation-resistant light-transmitting structure, the at least one bottom radiation-resistant structure, and the radiation-resistant lamp support structure are all made of materials consisting of low atomic number elements or stable isotopes;
wherein the at least one illumination light-generating structure, the at least one top radiation-resistant structure, the at least one radiation-resistant light-transmitting structure, the at least one bottom radiation-resistant structure, and the radiation-resistant lamp support structure are all interconnected through a plurality of locking elements without welding;
wherein the at least one illumination light-generating structure, the at least one top radiation-resistant structure, the at least one radiation-resistant light-transmitting structure, the at least one bottom radiation-resistant structure, and the radiation-resistant lamp support structure are all made of high-temperature resistant materials suitable for temperatures below 150° C.; and
wherein the radiation-resistant LED lamp module internally contains a low-temperature activation zirconium-based getter and a high-efficiency molecular sieve desiccant.

5. A radiation-resistant LED lamp module, comprising:
at least one illumination light-generating structure including a circuit substrate and a plurality of LED elements disposed on the circuit substrate;
at least one top radiation-resistant structure including a top radiation-resistant element disposed above the at least one illumination light-generating structure;
at least one radiation-resistant light-transmitting structure including a first radiation-resistant light-transmitting element disposed above the at least one illumination light-generating structure, and a second radiation-resistant light-transmitting element disposed above the first radiation-resistant light-transmitting element; and
at least one bottom radiation-resistant structure including a bottom radiation-resistant element disposed below the at least one illumination light-generating structure;
wherein the first radiation-resistant light-transmitting element is configured as one of a first lead-containing light-transmitting element and a first boron-containing light-transmitting element that is detachably disposed above the at least one illumination light-generating structure, and the second radiation-resistant light-transmitting element is configured as one of a second lead-containing light-transmitting element and a second boron-containing light-transmitting element that is detachably disposed above the at least one illumination light-generating structure.

6. The radiation-resistant LED lamp module according to claim 5,
wherein the at least one illumination-generating structure further includes a plurality of electronic components disposed on the circuit substrate and a radiation-resistant insulating cover disposed on the circuit substrate to cover the electronic components;
wherein the circuit substrate is configured as a ceramic substrate or a metal core printed circuit board;
wherein each of the LED elements is configured as an AC LED chip, each of the electronic components is configured as one of a capacitor, an inductor, a resistor, a current-limiting element, and a rectifier, and the radiation-resistant insulating cover is configured as a titanium-containing insulating cover;
wherein a vertical projection of each of the LED elements falls entirely on the first radiation-resistant light-transmitting element and the at least one bottom radiation-resistant structure, and a vertical projection of each of the electronic components falls entirely on the top radiation-resistant element and the at least one bottom radiation-resistant structure;
wherein the first radiation-resistant light-transmitting element is configured to be detachably disposed on a reflector cup element, and the second radiation-resistant light-transmitting element is configured to be detachably disposed on a lamp housing;
wherein, when the first radiation-resistant light-transmitting element is configured as the first lead-containing light-transmitting element, the first lead-containing light-transmitting element is configured as one of a first lead-containing glass plate and a first lead-containing plastic plate;
wherein, when the first radiation-resistant light-transmitting element is configured as the first boron-containing light-transmitting element, the first boron-containing light-transmitting element is configured as one of a first boron-containing glass plate and a first boron-containing plastic plate;
wherein, when the second radiation-resistant light-transmitting element is configured as the second lead-containing light-transmitting element, the second lead-containing light-transmitting element is configured as one of a second lead-containing glass plate and a second lead-containing plastic plate;
wherein, when the second radiation-resistant light-transmitting element is configured as the second boron-containing light-transmitting element, the second boron-containing light-transmitting element is configured as one of a second boron-containing glass plate and a second boron-containing plastic plate;
wherein the first radiation-resistant light-transmitting element is configured as a first radiation-resistant light-transmitting plate without through holes, and the second radiation-resistant light-transmitting element is configured as a second radiation-resistant light-transmitting plate without through holes;
wherein the first radiation-resistant light-transmitting element is detachably disposed above the at least one illumination light-generating structure through at least one first position-limiting structure, and the second radiation-resistant light-transmitting element is detachably disposed above the first radiation-resistant light-transmitting element through a second position-limiting structure; and
wherein the second radiation-resistant light-transmitting element has an outer surrounding region that is configured to provide information about radiation resistance levels.

7. The radiation-resistant LED lamp module according to claim 5,
wherein the first radiation-resistant light-transmitting element and the second radiation-resistant light-transmitting element are configured to be separate from each other by a predetermined distance or stacked on top of each other;
wherein, when the first radiation-resistant light-transmitting element and the second radiation-resistant light-transmitting element are configured to be separate from each other by the predetermined distance, the radiation-resistant LED lamp module further comprises: at least one light reflector structure disposed between the at least one illumination light-generating structure and the first radiation-resistant light-transmitting element;
wherein the at least one light reflector structure includes a support base disposed on the at least one illumination light-generating structure and a reflector cup element surroundingly connected to the support base;
wherein the reflector cup element is configured to support the first radiation-resistant light-transmitting element;
wherein the top radiation-resistant element has a through opening for exposing the LED elements, and the support base has a through opening for exposing the LED elements;
wherein, when the LED elements are configured to generate an illumination beam, the illumination beam generated by the LED elements sequentially passes through the through opening of the top radiation-resistant element, the through opening of the support base, the first radiation-resistant light-transmitting element, and the second radiation-resistant light-transmitting element;
wherein the at least one illumination light-generating structure, the at least one top radiation-resistant structure, the at least one radiation-resistant light-transmitting structure, the at least one bottom radiation-resistant structure, and the at least one light reflector structure are all made of materials consisting of low atomic number elements or stable isotopes;
wherein the at least one illumination light-generating structure, the at least one top radiation-resistant structure, the at least one radiation-resistant light-transmitting structure, the at least one bottom radiation-resistant structure, and the at least one light reflector structure are all interconnected through a plurality of locking elements without welding; and
wherein the at least one illumination light-generating structure, the at least one top radiation-resistant structure, the at least one radiation-resistant light-transmitting structure, the at least one bottom radiation-resistant structure, and the at least one light reflector structure are all made of high-temperature resistant materials suitable for temperatures below 150° C.

8. The radiation-resistant LED lamp module according to claim 5,
wherein the radiation-resistant LED lamp module further comprises: a radiation-resistant lamp support structure including a lamp housing and a stainless steel support base detachably disposed on the lamp housing;
wherein the lamp housing is configured to be detachably and movably disposed on a ceiling support structure;
wherein the top radiation-resistant element is configured as a lead-containing surrounding cover plate detachably disposed on the at least one illumination light-generating structure, and the bottom radiation-resistant element is configured as a radiation-resistant heat dissipation element detachably contacting the circuit substrate;
wherein a thickness of the top radiation-resistant element is between 1000 μm and 5000 μm, a thickness of the first radiation-resistant light-transmitting element is between 1000 μm and 5000 μm, a thickness of the second radiation-resistant light-transmitting element is between 1000 μm and 5000 μm, a thickness of the bottom radiation-resistant element is between 1000 μm and 5000 μm, and a thickness of the stainless steel support base is between 1000 μm and 5000 μm;
wherein the at least one illumination light-generating structure, the at least one top radiation-resistant structure, the at least one radiation-resistant light-transmitting structure, the at least one bottom radiation-resistant structure, and the radiation-resistant lamp support structure are all made of materials consisting of low atomic number elements or stable isotopes;
wherein the at least one illumination light-generating structure, the at least one top radiation-resistant structure, the at least one radiation-resistant light-transmitting structure, the at least one bottom radiation-resistant structure, and the radiation-resistant lamp support structure are all interconnected through a plurality of locking elements without welding;
wherein the at least one illumination light-generating structure, the at least one top radiation-resistant structure, the at least one radiation-resistant light-transmitting structure, the at least one bottom radiation-resistant structure, and the radiation-resistant lamp support structure are all made of high-temperature resistant materials suitable for temperatures below 150° C.; and
wherein the radiation-resistant LED lamp module internally contains a low-temperature activation zirconium-based getter and a high-efficiency molecular sieve desiccant.

9. A radiation-resistant LED lamp module, comprising:
at least one illumination light-generating structure including a circuit substrate and a plurality of LED elements disposed on the circuit substrate;
at least one top radiation-resistant structure including a top radiation-resistant element disposed above the at least one illumination light-generating structure;
at least one radiation-resistant light-transmitting structure including a first radiation-resistant light-transmitting element disposed above the at least one illumination light-generating structure, and a second radiation-resistant light-transmitting element disposed above the first radiation-resistant light-transmitting element; and
at least one bottom radiation-resistant structure including a bottom radiation-resistant element disposed below the at least one illumination light-generating structure;
wherein the at least one illumination light-generating structure is enclosed by the top radiation-resistant element, the first radiation-resistant light-transmitting element, and the bottom radiation-resistant element.

10. The radiation-resistant LED lamp module according to claim 9,
wherein the at least one illumination-generating structure further includes a plurality of electronic components disposed on the circuit substrate and a radiation-resistant insulating cover disposed on the circuit substrate to cover the electronic components;
wherein the circuit substrate is configured as a ceramic substrate or a metal core printed circuit board;
wherein a vertical projection of each of the LED elements falls entirely on the first radiation-resistant light-transmitting element and the at least one bottom radiation-resistant structure, and a vertical projection of each of the electronic components falls entirely on the top radiation-resistant element and the at least one bottom radiation-resistant structure;
wherein the first radiation-resistant light-transmitting element is configured as a first radiation-resistant light-transmitting plate without through holes, and the second radiation-resistant light-transmitting element is configured as a second radiation-resistant light-transmitting plate without through holes;
wherein the first radiation-resistant light-transmitting element is detachably disposed above the at least one illumination light-generating structure through at least one first position-limiting structure, and the second radiation-resistant light-transmitting element is detachably disposed above the first radiation-resistant light-transmitting element through a second position-limiting structure;
wherein the second radiation-resistant light-transmitting element has an outer surrounding region that is configured to provide information about radiation resistance levels;
wherein the radiation-resistant LED lamp module further comprises: at least one light reflector structure disposed between the at least one illumination light-generating structure and the first radiation-resistant light-transmitting element;
wherein the at least one light reflector structure includes a support base disposed on the at least one illumination light-generating structure and a reflector cup element surroundingly connected to the support base;
wherein the radiation-resistant LED lamp module further comprises: a radiation-resistant lamp support structure including a lamp housing and a stainless steel support base detachably disposed on the lamp housing;
wherein the top radiation-resistant element is configured as a lead-containing surrounding cover plate detachably disposed on the at least one illumination light-generating structure, and the bottom radiation-resistant element is configured as a radiation-resistant heat dissipation element detachably contacting the circuit substrate;
wherein the at least one illumination light-generating structure, the at least one top radiation-resistant structure, the at least one radiation-resistant light-transmitting structure, the at least one bottom radiation-resistant structure, the at least one light reflector structure and the radiation-resistant lamp support structure are all made of materials consisting of low atomic number elements or stable isotopes;
wherein the at least one illumination light-generating structure, the at least one top radiation-resistant structure, the at least one radiation-resistant light-transmitting structure, the at least one bottom radiation-resistant structure, the at least one light reflector structure and the radiation-resistant lamp support structure are all interconnected through a plurality of locking elements without welding;
wherein the at least one illumination light-generating structure, the at least one top radiation-resistant structure, the at least one radiation-resistant light-transmitting structure, the at least one bottom radiation-resistant structure, the at least one light reflector structure and the radiation-resistant lamp support structure are all made of high-temperature resistant materials suitable for temperatures below 150° C.; and
wherein the radiation-resistant LED lamp module internally contains a low-temperature activation zirconium-based getter and a high-efficiency molecular sieve desiccant.
